(19) United States
(12) Patent Application Publication
(10) Pub. No.: US 2009/0325005 A1
(43) Pub. Date: Dec. 31, 2009

(54) ELECTROLYTIC MEMBRANE

(76) Inventors: Gijsbertus Hendrikus Maria Calis, Hulsberg (NL); Edwin Henricus Adriaan Steenbakkers, Voerendaal (NL)

Correspondence Address: NIXON & VANDERHYE, PC, 901 NORTH GLEBE ROAD, 11TH FLOOR, ARLINGTON, VA, 22203, US

(21) Appl. No.: 12/374,614

(22) PCT Filed: Jul. 18, 2007
(86) PCT No.: PCT/EP07/06373

§ 371 Date: Jul. 20, 2009

(30) Foreign Application Priority Data
Jul. 20, 2006 (EP) 06015100.8

(51) Int. Cl. H01M 8/04; H01M 8/10; H01M 4/82; H01M 10/44

(52) U.S. Cl. 429/13; 429/33; 264/104; 429/50

(57) ABSTRACT

An electrolyte membrane comprising a reinforcement structure and an ionomer is provided. The reinforcement structure comprises a plurality of pores with a diameter of 0.3 μm to 2.5 μm as established by a PMI Capillary Flow Porometer and exhibit a linear swelling expansion below 0.5% for all directions in the X-Y plane. Furthermore, a method of manufacturing such electrolyte membranes is provided. The electrolyte membrane is particularly suitable for application as electrolyte membrane in low temperature fuel cells, such as polymer exchange fuel cells and direct methanol fuel cells, and in electrolysis cells.

The invention relates to electrolyte membranes for electrochemical cells comprising a reinforcement structure and an ionomer arranged at least partially in pores of the reinforcement structure. Particularly, the present invention relates to electrolyte membranes which exhibit very little linear swelling expansion.

Electrolyte membranes in fuel cells are facing frequent variation in humidity due to the variation in operation conditions during use as well as during the start-up and shut-down procedures.

One of the major concerns in the field of proton exchange membrane fuel cell (PEMFC) technology is the durability. It has been found that the durability is related to the linear expansion upon changing of humidity. The acceptable linear expansion depends to a large extend on the mechanical properties of the electrolyte membrane as well as the properties of the supporting members, seals etc., but it may be estimated to be about maximum 0.5% in all directions in the x-y plane, i.e. parallel to the surface of the membrane.

Another important concern in the field of PEMFC technology is to achieve a high degree of filling of the pores with the ionomer to achieve a high OCV. The leaching of ionomer from the pores during use is another major concern with regard to durability.

Electrolyte membranes are known for example from EP 1 263 066, which in Example 1 discloses an electrolyte membrane with a reinforcement film consisting of 56% UHMWPE (with MW ca. 2,500,000 g/mol) and 44% HMWPE (with MW ca. 400.000 g/mol) and a pore size of the reinforcing film of 0.7 μm. This electrolyte membrane exhibits a linear expansion of 1% in the machine direction and 4% and the transverse direction parallel to the film surface.

Another electrolyte membrane is disclosed in JP 62-179168 (application number), wherein a reinforcement film consisting of UHMWPE with MW of 500.000-10.000.000 is provided. In the specification, a through-pore diameter of 0.001-1 μm determined by the method of particle permeation is suggested. However, the disclosed experimental work discloses that the through-pore diameter according to the paraffin method specifically used in JP 62-179168 rather is about 0.01-0.085 μm, which corresponds to the preferred range in JP 62-179168 of 0.005-0.1 μm and hence provides pores with a maximum average through-pore diameter at least one order of magnitude smaller than the suggested maximum in JP 62-179168 of 1 μm. The small pore diameter obtainable by the paraffin method leads to difficulties in impregnating with ionomer, which is acknowledged in the specification of JP 62-179168 in that ultrasonic cavitation or degassing by pressure reduction is required for the impregnation. JP 62-179168 does not concern durability issues of the electrolyte membrane.

Yet another electrolyte membrane is disclosed in EP 0 950 075. This electrolyte membrane provides a pore size of 0.1 to 5 μm with MW in the examples of 140.000 and 450.000. The membrane exhibits a very high OCV, which is most likely due to the large pore size. It is found that even if polymer with higher MW may be present, the best results are realised for polyethylene membranes with a weight-average molecular weight less than 500,000 g/mol. Durability issues regarding drop in open cell voltage (OCV) due to leaching of ionomer is discussed.

There is a long felt need for an electrolyte membrane, which exhibits a very low linear expansion upon changing of humidity. However, the low linear expansion must be realised while maintaining high OCV and low leaching of ionomer thus improving durability.

It is the object of the invention to provide an improved electrolyte membrane.

It is another object of the invention to a method of manufacturing the improved electrolyte.

One or more of the above and other objects of the invention are realised by an electrolyte membrane comprising a reinforcement structure, wherein the reinforcement structure consists substantially of a stretched UHMWPE film having a molecular weight of 500,000-10,000,000 g/mol with a plurality of pores. By ‘consist substantially of UHMWPE’ is here understood that minor amounts such as 0-5% of organic or inorganic additives may also be integrated in the reinforcement structure. It is emphasised that the ionomer and solvents are not considered to form part of the reinforcement structure.

The stretching should be conducted to realise a substantial increase in stiffness, preferably to a degree that the swelling expansion of the membrane is below 0.5%.

Water is typically also present in the electrolyte membrane due to the high affinity of typical ionomers towards water.

For the reinforcement structure, the X-Y plane is defined in the traditional way as being parallel with the main surface of the completed electrolyte membrane. This corresponds to the main surface of the reinforcement structure. The electrolyte membrane has an ionomer arranged at least partially in the plurality of pores. In other words, ionomer is present in at least some of the pores and the ionomer may also be present on for example the surface of the electrolyte membrane. It is highly preferred that the ionomer is present in all or substantially all pores of the reinforcement structure, as this leads to increased conductivity of the membrane. Filling of all pores is facilitated by the pore size specified according to the present invention.

Surprisingly, it was found that to achieve an adequate balance between the arrangement of ionomer into the pores, the leaching of ionomer from the pores and the conductivity (or OCV) of the electrolyte membrane, the mean diameter of the plurality of pores should be 0.3 μm to 2.5 μm as established by a PMI Capillary Flow Porometer as described below. In a preferred embodiment, the mean diameter of the plurality of pores is 0.5 μm to 2.0 μm. It was found that having a range of mean diameter of the plurality of pores from 0.5 μm to 1.0 μm was very advantageous, such as having a mean diameter of the plurality of pores of 0.5 μm to 0.85 μm.

Finally, the linear swelling expansion of the electrolyte membrane measured according to the method described below should be kept below 0.5% for all directions in the X-Y plane.

Another aspect of the invention concerns a method of manufacturing of an electrolyte membrane. The method is based on the teachings of EP 0 950 075, (aspects relating to the manufacturing method of EP 0 950 075 are incorporated herein by reference) and comprises the steps of providing a reinforcement structure consisting substantially of a stretched UHMWPE film having a molecular weight of 500,000-10,000,000 g/mol with a plurality of pores. To realise an optimum balance between the arrangement of ionomer into the pores, the leaching of ionomer from the pores and OCV of the electrolyte membrane, the mean diameter of the plurality of pores is 0.3 μm to 2.5 μm as established by a PMI Capillary Flow Porometer as described below. Particularly, if was found to be advantageous to have a mean diameter of the plurality of pores of 0.5 μm to 2.0 μm as measured by a PMI Capillary Flow Porometer, such as 0.5 μm to 1.0 μm and particularly 0.5 μm to 0.85 μm.

The reinforcement structure is then stretched in at least one direction in the X-Y plane. The stretching straightens the polymer fibrils of the reinforcement structure, thereby increasing the stiffness (i.e. E-modulus) of the reinforcement structure. Typically, the reinforcement structure is stretched in at least two directions in the X-Y plane as discussed elsewhere. The stretching should preferably be to a strain corresponding to at least 80% of the ultimate tensile strength of the reinforcement structure, as this ensures a very high degree of orientation of the polymer fibrils. In another embodiment, the stretching should preferably be to a strain corresponding to at least 80% of the ultimate elongation of the reinforcement structure, as this also ensures a very high degree of orientation of the polymer fibrils. The high degree of orientation again leads to very high E-modulus providing a very stiff overall membrane.

After stretching, but not necessarily immediately thereafter, an ionomer is arranged at least partially in the plurality of pores. The arrangement may for example involve infusion of gas or liquid, or impregnation and may be facilitated by means of pressure or vacuum.

### Abbreviations

Unless otherwise explicitly stated, the following abbreviations are utilised throughout the present description.

### PE: Polyethylene

MW: Weight-average molecular weight
UHMWPE: Ultra high (weight-average) molecular weight polyethylene. This corresponds to MW of 500,000-10,000,000 g/mol

### PTFE: Polytetrafluorethylene

Linear swelling expansion

The amount of water bound to the ionomer in the electrolyte membrane varies considerably with for example temperature and humidity. This may be observed as an expansion/contraction of the ionomer, when the humidity is increased/decreased, respectively. The expansion due to uptake of water is herein referred to as swelling expansion. The temperature and humidity may vary considerably both locally and overall during use of an electrolyte membrane in for example a fuel cell due to variation in loading and presence of local structural, mechanical or chemical inhomogeneities. Therefore, linear swelling expansion will result in introducing cyclic or periodic stress of the system, which again may lead to failure of seals or even the electrolyte membrane during use.

Swelling expansion takes place in both the X-Y plane corresponding to the stretching plane and in the Z direction, i.e. normal to the surface of the electrolyte membrane. However, for structural reasons only the expansion in the X-Y plane is of importance for integrity of the system during use in fuel cells. Hence, all measurements refer to swelling expansion in the X-Y plane and are referred to as linear swelling expansion.

Other expansion/contraction processes may also take place during use, such as thermal expansion and stretching relaxation. The magnitudes of the effects vary for example with the type of polymer and the sample history (e.g. stretching pattern, the number of cycles and magnitude of variation). It was found that stretching relaxation was limited in the PE system, and particularly for UHMWPE this effect could be ignored after the first temperature/humidity cycle.

The measurement of linear swelling expansion of the electrolytic membrane follows the measurement of linear expansion under ASTM D 756 as described in DuPont Product Information on Nafion PFSA Membranes, N-1 12, NE-1135, N-115, N-117, NE-1110 (NAE101 (Feb2004)). Samples are formed by electrolytic membrane films with a thickness of 25-100 μm. The linear swelling expansion is measured by first conditioning the sample at 50% relative humidity at 23° C. Thereafter, the sample is subjected to boiling water for one hour followed by removing from the water and directly measuring the expanded length. Finally, the sample was again conditioned at 50% relative humidity at 23° C. and the length was measured.

To reduce the influence of thermal expansion on the measurement, all length measurements were conducted at room temperature. It should be observed that temperature equilibration to room temperature was substantially immediate due to the shape of the samples.

Experimental work has shown that the linear swelling expansion in the PE system should be below 0.5% as measured by the method described below. Furthermore, experimental work has shown that the main factors in deciding the linear swelling expansion are the composition and the stretching history of the reinforcement structure.

Pore size measurement

Due to the stretching of the reinforcement structure, the polymer is highly oriented parallel to the surface of the reinforcement structure, i.e. parallel to the surface of the final membrane. This leads to a substantially layered structure with the shape of the pores being far from pipe-shaped. The pore diameter is therefore defined as the value realised by the pore size measurement as described below, and it should be observed that this value not necessarily is the same as what could be observed by e.g. micrographs. The measured pore diameter rather represents a value for pore size which may be compared to similarly measured pore diameters for members having substantially the same structure. References to (medium) pore size and (medium) pore diameters herein are therefore related to the values obtained by the following method.

The pore size of the stretched reinforcement structure is measured by a PMI (Porous Materials Inc., USA), Capillary Flow Porometer, CFP-1500-AG, in standard porosity mode, which is the typical porosity measurement in the field of electrolytic membranes. For all measurements Fluor Inert (FC-40) was used as a wetting agent to wet the samples prior to the measurement.

Mechanical properties

Mechanical properties including tensile stress and elongation at breakage is measured according to ASTM D882/00. Young's modulus is calculated as the ultimate strength divided by elongation at breakage for the membranes.

### DETAILED DESCRIPTION

In a preferred embodiment, the mean diameter of the pores is 0.5 μm to 2.0 μm as established by a PMI Capillary Flow Porometer as described elsewhere. More preferably the mean diameter of the pores is 0.5 μm to 1.0 μm, and most preferably the mean diameter of the pores is 0.5 μm to 0.85 μm as established by the PMI Capillary Flow Porometer. This range represents the best mode known to the inventors, as it provides the best trade off between ease of introduction of ionomer into the pores, very limited leaching of ionomer from the pores and high OCV of the electrolyte membrane.

In another preferred embodiment, the linear swelling expansion of the electrolyte membrane is below 0.4% for all directions parallel to the surface of the electrolyte membrane. This provides a highly advantageous margin to the general max 0.5% level, which margin may take into account local variation in material properties and conditions and hence further increase in durability of the electrolyte membrane.

In a highly preferred embodiment, the reinforcement structure consists substantially of UHMWPE with a weight-average molecular weight of about 1,000,000 to 5,000,000 g/mol. This allows for a reinforcement structure with very low swelling expansion.

In most advantageous embodiment, the reinforcement structure consists substantially of UHMWPE. By ‘consist substantially of’ is here understood that minor amounts such as a total of 0-5% of other polymers (such as PE, which is not UMWPE, PP, PVA, PTFE; , organic or inorganic additives, such as surfactants; or fillers, such as inorganic fibres, carbon black, SiO₂), may also be integrated in the reinforcement structure. It is emphasised that the ionomer and solvents are not considered to form part of the reinforcement structure. It could be theorised that the UHMWPE and particularly the pure UHMWPE are favourable due to the high resistance to further stretching in the X-Y plane of the reinforcement structure when the polymer fibrils are oriented parallel to this layer, since the resistance to further stretching hinders the ionomer from expanding upon interaction with water. In other words, the E-modulus of the reinforcement structure is very high and the swelling expansion is kept low as specified according to the present invention.

To realise the desired structure and hence properties of the reinforcement structure, the reinforcement structure is stretched during manufacturing. This also increases the stiffness of the reinforcement structure. The stretching should be conducted to realise sufficient increase in stiffness so that the swelling expansion of the membrane is below 0.5%. The stretching may be in one or more directions in the X-Y plane, i.e. parallel to the surface of the final electrolyte membrane. To realise a more homogeneous structure in the X-Y plane, it is preferred to stretch the reinforcement structure in at least two directions. The stretching may be simultaneous in several directions, consecutive (i.e. first completed in a first direction and then in a second direction) or alternating in two or more directions. It was found that stretching in two directions provided a suitable combination of material properties and processing expenses. Typically, the area stretching factor is in the order of 20-50 with stretching in the machine direction of about 3-6 and in the transverse direction of about 5-8.

Partially as a result of the stretching, the reinforcement structure has a somewhat layered structure. This should be understood in the sense that the pores as well the polymer fibrils are oriented mainly parallel to the X-Y plane of the reinforcement structure. This allows for a high resistance to further stretching in the X-Y plane, which tend to reduce the linear swelling expansion in the X-Y plane. The layered structure hence does not consist of strictly separated layers but it is rather an overall orientation of the components (reinforcement phase and ionomer phase) in a co-continuous structure.

Experimental work has shown that the linear swelling expansion depends on the degree of orientation of the polymer of the reinforcement structure. Particularly, it was found to be advantageous to stretch the reinforcement structure in at least one direction in the X-Y plane to a strain corresponding to at least 80% of the ultimate strength of the reinforcement structure. Alternatively, it was also found to be advantageous to stretch the reinforcement structure in at least one direction in the X-Y plane to an elongation corresponding to at least 80% of the elongation at breakage. Experimental work has shown that for UHMWPE this ensured a sufficient degree of orientation of the polymer that the linear swelling expansion was below 0.5% in the X-Y plane.

It was also found that particularly advantageous electrolyte membranes were those having a reinforcement structure with a high content of UHMWPE wherein at least 80% of the PE fibrils of the reinforcement structure were aligned substantially parallel to the X-Y plane of the reinforcement structure. By being aligned parallel to the surface of the membrane is here meant that when a straight line is drawn between the ends of the fibril, this straight line forms an angle to the X-Y plane of the membrane of less than 15°.

In a preferred embodiment, the electrolyte membrane has a Young's modulus of at least 115 MPa. This leads to a very stiff membrane, which facilitate realizing a swelling expansion of less than 0.5%. In a highly preferred embodiment, the electrolyte membrane has a Young's modulus of 120 to 150 MPa.

The pore fraction of the reinforcement structure should be high, such as for example at least 50% to ensure a continuous ionomer phase after introduction of the ionomer. In a preferred embodiment, the volume of the plurality of pores is at least 70% of the total volume of the reinforcement structure. By total volume of the reinforcement structure is herein meant the bulk volume including (dense) reinforcement material (e.g. UHMWPE) and pores (air/solvent/ionomer). The volume of the plurality of pores may be very high, but it is limited by the required stiffness or resistance to further stretching of the reinforcement structure, as the linear swelling expansion should be kept below 0.5% as described elsewhere. For a reinforcement structure with substantially pure UHMWPE it was found that the optimum volume of the plurality of pores is 75% to 90% of the total volume of the reinforcement structure.

In principle, the pores should preferably be completely filled by ionomer, however, this may require inadequate time and/or processing control. In the present work it was found that it is advantageous that the ionomer takes up at least 80%, such as 80-100%, of the volume of the plurality of pores.

The preferred embodiment of the electrolyte membrane according to the present invention combines high mechanical strength due to the UHMW with a high and durable OCV due to the optimized pore size. Good structural durability is realized by the low linear swelling expansion. Furthermore, a high Gurley value of 10.000 s/50 ml or more, i.e. low gas permeation through the membrane, is also realized. This combination is highly advantageous for the use as electrolyte membrane in low temperature fuel cells, such as solid-polymer fuel cells, polymer exchange fuel cells and direct methanol fuel cells (DMFC). For fuel cell applications, the electrolyte membrane according to the invention forms a crucial element of the system.

Methanol has also a large affinity for interacting with the ionomer and in the case of direct methanol fuel cell, this may lead to transfer of methanol through the electrolytic membrane. For the electrolytic membranes according to the present invention, the linear swelling expansion due to interaction between the ionomer and the methanol is also heavily constrained, which reduces the transfer of methanol through the membrane and hence improves the efficiency of the direct methanol fuel cell considerably. It could be theorized that this effect is realized by restraining the expansion of the ionomer and hence preventing or at least limiting the uptake of methanol in the membrane.

Another highly advantageous application of the electrolyte membrane according to the invention is as electrolyte in electrolysis cells. In this application, the low gas permeation in combination with the high durability with regard to linear swelling expansion as well as for electrical properties is also essential. For electrolysis cell applications, the electrolyte membrane according to the invention forms a crucial element of the system.

An individual feature or combination of features from an embodiment of the invention described herein, as well as obvious variations thereof, are combinable with or exchangeable for features of the other embodiments described herein, unless the person skilled in the art would immediately realise that the resulting embodiment is not physically feasible.

### EXAMPLES

### Comparative example 1

Composite membrane according to EP 1 263 066. Solupor® 40C01 B, as used in the EP 1 263 066, is a combination of Solupor® 3P07A and Nafion®, obtained by impregnation of Nafion® dispersion DE-2020 in Solupor® 3P07A. The resulting composite membrane has a thickness of 25 um (23° C./50% relative humidity). The composition of Solupor® 3P07A is a mixture of Stamylan® UHMWPE (with Mw=2.500.000 g/mol) and HMWPE (wiith Mw=400.000 g/mol). The material was stretched 30× by area.

Samples have been prepared of 15×170 mm, with 2 samples in the machine direction (MD) and 2 samples in the transverse direction (TD), and a sample length of 100 mm was indicated between two markers on each of the prepared samples. Sample weights were determined (23° C./50% RH). The samples were subsequently immersed into a bath of boiling de-ionized water at 100° C. for 1 hour. The length of the samples between the markers was measured directly after being removed from the water bath. For each sample the expansion due to water uptake was calculated according to the formula: {L(100° C./100% RH)-L(23° C./50% RH)}/ L(23° C./50% RH), where the length between the markers, L, is expressed in mm. The results have been collected in Table 1 (linear swelling expansion) and Table 2 (tensile strength, elongation and modulus).

### Comparative example 2

Casted non-reinforced membrane, produced from Nafion® DE-2020 dispersion.

Casting of Nafion® DE-2020 dispersion has been realized successfully after addition of 10% DMSO to the Nafion® dispersion. After 16 hours of drying at room temperature the cast Nafion® film was further dried at 120° C. for 1 hour and then removed from the casting plate. The film was then allowed to take up water at 23° C./50% RH for 4 hours, the resulting thickness was 30 um. The material was not stretched. Samples have been prepared according to the method described in Example 1 and after boiling at 100° C. for 1 hour the expansion in MD and TD were calculated as in Example 1.

### Comparative example 3

Micro-porous PTFE membrane, impregnated with Nafion® DE-2020 dispersion.

A stretched micro-porous PTFE membrane, type TX 2001 (Tetratex) was impregnated with Nafion® DE-2020 dispersion (after addition of 10% DMSO and 10% isopropyl-alcohol to the dispersion). Drying and conditioning of the composite membrane was carried out as described in Example 2. The linear swelling expansion was measured and calculated as in Example 1.

### Example 4

Micro-porous UHMWPE membrane, based on 100% UHMWPE impregnated with Nafion® DE-2020 dispersion.

A microporous membrane, consisting of 100% UHMWPE (MW=2,500,000 g/mol), is prepared in an extruder, which is fed with a suspension of 20 weight-% UHMWPE (MW=2,500,000) in decaline, which is subsequently quenched in decaline and dried with hot air. The resulting thick film was stretched biaxially to 33× by area at 120° C., thus providing a micro porous UHMWPE membrane. This membrane is impregnated with Nafion® DE-2020 dispersion (after addition of 10% DMSO and 10% isopropyl-alcohol to the dispersion). Drying and conditioning of the composite membrane has been carried out as was described in Example 2. The expansion due to water uptake has been measured and calculated as in Example 1.

TABLE 1
Swelling expansion of membranes of Example 1, 2, 3 and 4

| Example | 1-MD | | 2-MD | | AV-MD | 3-TD | | 4-TD | | AV-TD |
|---|---|---|---|---|---|---|---|---|---|---|
| 1 | 1 | mm | 0 | mm | 0.5% | 4 | mm | 4 | mm | 4.0% |
| 2 | 20 | mm | 21 | mm | 20.5% | 19 | mm | 21 | mm | 20.0% |
| 3 | 12 | mm | 13 | mm | 12.5% | 10 | mm | 9 | mm | 9.5% |
| 4 | 0 | mm | −0.5 | mm | −0.3% | 0 | mm | −0.5 | mm | −0.3% |

After measuring the swelling expansion the samples were conditioned again at 23° C./50% RH. For examples 1, 2 and 4 the dimensions were the same as after the first conditioning within 0.3%.

It may be assumed that the linear swelling expansion in other directions in the X-Y plane may be estimated by a linear combination of the linear swelling expansion in the X direction (e.g. the machine direction, MD) and the Y direction (e.g. the transverse direction, TC). In Table 1 it is observed that the linear swelling expansion for example 1-3 are considerably higher that the acceptable 0.5%, whereas for the composition according to the present invention, example 4, the linear swelling expansion is below 0.5% and basically about the lower limit of the measurement method.

TABLE 2
Mechanical properties of membranes of Examples 1, 2, 3 and 4

| | Tensile | Tensile | Elongation | Elongation | | |
|---|---|---|---|---|---|---|
| | Str MD, | Str TD, | at breakage | at breakage | Modulus | Modulus |
| Example | MPa | MPa | MD, % | TD, % | MD, MPa | TD, MPa |
| 1 | 14 | 11 | 13 | 10 | 108 | 110 |
| 2 | 43 | 32 | 225 | 310 | 19 | 10 |
| 3 | 18 | 21 | 84 | 59 | 21 | 36 |
| 4 | 16 | 13 | 13 | 11 | 124 | 120 |

In Table 2 it is observed that the modulus of sample 4 (a membrane according to the invention) is larger than the modulus of the other samples. The variation in the machine direction (MD) and the transverse direction (TD) originates from the processing. In other words, the sample 4 membrane is significantly stiffer than the other samples and the linear swelling expansion is thereby kept below the acceptable 0.5%. Particularly, it is observed that despite the variation in tensile strength between MD and TD, the modulus for the samples of Example 4 has a very high modulus in both MD and TD.

1. An electrolyte membrane comprising a reinforcement structure consisting substantially of a stretched UHMWPE film having a molecular weight of 500,000-10,000,000 g/mol with a plurality of pores, the reinforcement structure has a X-Y plane parallel to a surface of the electrolyte membrane, the electrolyte membrane having an ionomer arranged at least partially in the plurality of pores, wherein the mean diameter of the plurality of pores is 0.3 μm to 2.5 μm as established by a PMI Capillary Flow Porometer, and the linear swelling expansion of the electrolyte membrane is below 0.5% for all directions in the X-Y plane.

2. Electrolyte membrane according to claim 1, wherein the mean diameter of the pores is 0.5 μm to 2.0 μm as established by a PMI Capillary Flow Porometer, preferably the mean diameter of the pores is 0.5 μm to 1.0 μm, and more preferably the mean diameter of the pores is 0.5 μm to 0.85 μm.

3. Electrolyte membrane according to claim 1, wherein the linear swelling expansion of the electrolyte membrane is below 0.4% for all directions parallel to the surface of the electrolyte membrane.

4. Electrolyte membrane according to claim 1, wherein the membrane has a thickness of 5 to 50 μm, preferably the electrolyte membrane has a thickness of 10 to 25 μm.

5. Electrolyte membrane according to claim 1, wherein the electrolyte membrane has a Young's modulus of at least 115 MPa, preferably the electrolyte membrane has a Young's modulus of 120 to 150 MPa.

6. Electrolyte membrane according to claim 1, wherein the reinforcement structure consists substantially of UHMWPE with a weight average molecular weight of 1,000,000-5,000,000 g/mol.

7. Electrolyte membrane according to claim 1, wherein the reinforcement structure is a layered structure.

8. Electrolyte membrane according to claim 4, wherein at least 80% of UHMWPE fibrils are aligned substantially parallel to the X-Y plane of the reinforcement structure.

9. Electrolyte membrane according to claim 1, wherein the PE fibrils are aligned corresponding to stretching in at least one direction in the X-Y plane of the reinforcement structure to a strain corresponding to at least 80% of the ultimate strength of the reinforcement structure.

10. Electrolyte membrane according to claim 1, wherein the PE fibrils are aligned corresponding to stretching in at least one direction in the X-Y plane of the reinforcement structure to a strain corresponding to at least 80% of the ultimate elongation of the reinforcement structure.

11. Electrolyte membrane according to claim 1, wherein the volume of the plurality of pores is at least 50% of the total volume of the reinforcement structure, preferably the volume of the plurality of pores is at least 70% of the total volume of the reinforcement structure and most preferably the volume of the plurality of pores is between 75% to 90% of the total volume of the reinforcement structure.

12. Electrolyte membrane according to claim 1, wherein the ionomer takes up at least 80% of the volume of the plurality of pores, preferably the ionomer substantially fills the plurality of pores, such as 90 to 100% of the volume of the plurality of pores.

13. Fuel cell comprising an electrolyte membrane according claim 1.

14. Use of an electrolyte membrane according to claim 1 as an electrolyte in a direct methanol fuel cell (DMFC).

15. Use of an electrolyte membrane according to claim 1 as an electrolyte in a electrolysis cell.

16. A method of manufacturing an electrolyte membrane according to claim 1, comprising the steps of
providing a reinforcement structure consisting substantially of a stretched UHMWPE with a molecular weight of 500,000-10,000,000 g/mol with a plurality of pores, the reinforcement structure has an X-Y plane parallel to a surface of the electrolyte membrane,
stretching the reinforcement structure in at least one direction,
arranging a ionomer at least partially in the plurality of pores, wherein the reinforcement structure reinforcement structure is stretched in at least one direction in the X-Y plane of the reinforcement structure to a strain corresponding to at least 80% of the ultimate tensile strength of the reinforcement structure and the mean diameter of the plurality of pores is 0.3 μm to 2.5 μm as established by a PMI Capillary Flow Porometer, preferably the mean diameter of the pores is 0.5 μm to 2.0 μm, more preferably the mean diameter of the pores is 0.5 μm to 1.0 μm and most preferably the mean diameter of the plurality of pores is 0.5 μm to 0.85 μm.

17. Method according to claim 16, wherein the reinforcement structure consists substantially of UHMWPE with a molecular weight of 1,000,000-5,000,000 g/mol.

18. Method according to claim 16, wherein the electrolyte membrane has been stretched to a Young's modulus of at least 115 MPa, preferably the electrolyte membrane has a Young's modulus of 120 to 150 MPa.

19. Method according to claim 16, wherein the reinforcement structure is stretched in at least two directions, preferably the reinforcement structure is stretched in two directions.
